(19) United States
(12) Patent Application Publication
(10) Pub. No.: US 2025/0124581 A1
(43) Pub. Date: Apr. 17, 2025

(54) ABSOLUTE LONGITUDINAL LOCALIZATION OF A MOVING OBJECT ON THE NON-LINEAR SECTIONS OF A TRAJECTORY DESCRIBED BY A CONTINUOUS CURVE

(71) Applicant: Oracle International Corporation, Redwood Shores, CA (US)

(72) Inventors: Sergio Aldea Lopez, Valladolid (ES); Sahil Malhotra, Hampton (GB); Matthew Charles Rowe, Milton Keynes (GB); Oleg Gennadievich Shevelev, Chislehurst (GB); Alberto Polleri, London (GB)

(21) Appl. No.: 18/380,095

(22) Filed: Oct. 13, 2023

(51) Int. Cl. G06T 7/20; G06T 7/13; G06T 7/70; G06V 10/24; G06V 10/74

(52) U.S. Cl. CPC G06T 7/20; G06T 7/13; G06T 7/70; G06V 10/245; G06V 10/761; G06T 2207/30241

(57) ABSTRACT

Techniques for determining an absolute longitudinal position of a moving object on non-linear sections of a trajectory are described. In one technique, an estimated track boundary segment is generated based on a digital image associated with a moving object. For each position of multiple positions in an actual track boundary segment pertaining to a track for one or more moving objects, an alignment of the estimated track boundary segment with the actual track boundary segment is made based on that position. Also, based on the alignment, a difference measurement between the estimated track boundary segment and a portion of the actual track boundary segment is generated. After each of the positions is considered, a particular alignment, of multiple alignments, that is associated with the lowest difference measurement among the multiple positions is selected. Based on the particular alignment, a longitudinal value of the moving object is determined.

### TECHNICAL FIELD

The present disclosure generally relates to object localization and, more specifically, to determining a longitudinal position of a moving object on non-linear sections of a trajectory.

### BACKGROUND

Absolute localization of a moving object (such as a vehicle) in its context (such as a road or a racing track) typically requires a combination of different signals, such as GPS, multiple cameras, depth estimators, etc. Some of these methods have issues estimating the absolute position of the moving object when there is a sudden change in its moving pattern, such as when the moving object goes from a straight section to a curved section of its trajectory, or when the speed is very high. On top of these challenges, if the only available signal is the feed of a monocular camera, then, in the absence of any other signal, the absolute localization of the vehicle is a problem of significant difficulty.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section . . .

### BRIEF DESCRIPTION OF THE DRAWINGS

In the drawings:

FIG. 1 is a block diagram that depicts an example localization system 100, in an embodiment;

FIG. 2 is a block diagram that depicts a comparison between an actual track boundary segment and an estimated track boundary segment, in an embodiment;

FIG. 3 is a flow diagram that depicts an example process for determining a longitudinal position of a moving object along a trajectory, in an embodiment;

FIGS. 4 and 5 are diagrams that depict example plots or charts of point-wise distances between segments and probability distributions related to uncertainty of an estimated longitudinal value of a moving object, in an embodiment;

FIG. 6 is a block diagram that illustrates a computer system upon which an embodiment of the invention may be implemented;

FIG. 7 is a block diagram of a basic software system that may be employed for controlling the operation of the computer system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

A method and system for estimating the longitudinal position of a moving object with respect to track boundaries and a starting position are described. In one technique, an estimated or predicted track boundary is generated based on an image. The predicted track boundary is compared to (aligned with) multiple different segments of actual track boundary that is indicated in ground truth data. The segment that is associated with the smallest difference with respect to the predicted track boundary is used to determine the longitudinal position of a moving object associated with the image.

In a related technique, an uncertainty value indicating a level of uncertainty of the longitudinal position is generated based on residuals of the alignment method. In a related technique, the uncertainty value generation is optimized to reduce the number of measurements used to generate the uncertainty value.

Embodiments improve computer-related technology related to absolute localization. Embodiments localize the longitudinal position of an object that is moving at significant speeds, such as more than 300 km/h with a precision of under one meter. Embodiments produce an uncertainty of each generated longitudinal position, which allows for the fusing of the longitudinal position with estimations generated by other localization techniques, such as visual odometry techniques, which techniques may suffer from drift. Thus, embodiments may be used to immediately correct accumulated drift.

### System Overview

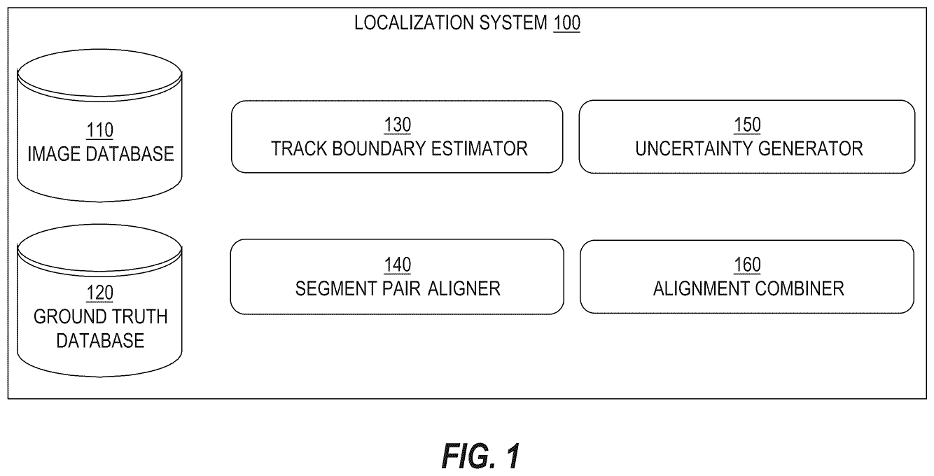

FIG. 1 is a block diagram that depicts an example localization system 100, in an embodiment. Localization system 100 includes an image database 110, a ground truth database 120, a track boundary estimator 130, a segment pair aligner 140, an uncertainty generator 150, an alignment combiner 160. Each of track boundary estimator 130, segment pair aligner 140, uncertainty generator 150, and alignment combiner 160 may be implemented in software, hardware, or any combination of software and hardware.

Image database 110 includes images from one or more video streams and/or video footages. For example, one or more moving objects, such as cars, airplanes, robots, drones, etc., have a digital camera that generates images (or a video stream) at each time interval, such as every 50 milliseconds, and yaw angle. The digital camera may be mounted on different parts of a moving object, such as the front of a car or the bottom of a flying drone.

Each image may be associated with an orientation value that indicates a direction in which the digital camera was facing when the digital camera generated the image. Each image may also be associated with geographic coordinates that may be used to determine, at least approximately, a portion of a track in which the digital camera was located at the time the digital camera generated the image. During the alignment stage, such geographic coordinates may be used to consider only the portions of the track in which the moving object could be located. This may increase accuracy, reduce time to generate the longitudinal position, and reduce uncertainty of the generated longitudinal position.

While images are depicted as being stored (e.g., persistently) in image database 110, suggesting that the images may have been stored therein for a considerable amount of time, image database 110 may be volatile memory that temporarily stores a stream of video that is being transmitted from a moving object whose position is being calculated in real-time.

Localization system 100 may be used to calculate the position of one or multiple moving objects in real-time. Thus, image database 110 may store images that were generated from different digital cameras mounted on (or otherwise attached to) different moving objects. Therefore, image database 110 may comprise multiple segments of volatile memory, each section storing image data from different digital cameras.

Ground truth database 120 stores data about one or more boundaries of a track. A track may have multiple boundaries, such as a left boundary and a right boundary, or may have a single boundary, such as an outer boundary that a moving object is not intended to cross. A track with one or more boundaries may also have one or more dividing lines, such as a center line that is roughly in-between the left boundary and the right boundary of a track, or dividing lines that define different lanes, such as on a track in a track and field setting. Examples of a track include a racetrack, a dirt path, and a volume in the air defined by a series of floating markers that define the edges of the volume. Boundaries may be visible marked by paint on pavement, cones, lights, and/or a change in the ground from track to non-track, such as from pavement to grass. Data about one or more boundaries of a track includes location data that define the one or more boundaries. Location data may include geographic coordinates of multiple points along the one or more boundaries and/or Cartesian coordinates of multiple points along in the one or more boundaries. The distance between each point of the multiple points may be one centimeter, a few (e.g., ten) centimeters, a half a meter or a meter, etc. The distance between each point may depend on how long the track is and/or other characteristics of the track.

### Per-Image Reference

Each image is associated with its own reference field defined by a bounding box of a fixed size, such as 40 meters×40 meters. The size of the bounding box may vary depending on the settings of the digital camera(s) that generated the image(s), such as aperture, field of view, and resolution; and the requirements of the specific application, such as width of the structure to be perceived and the distance to which it is to be perceived. For example, the position of the moving object relative to the image may be defined as {0, 0} in Cartesian space, where {−20, 0} would indicate a distance of 20 units (e.g., meters) to the left of the moving object, {20, 0} would indicate a distance of 20 units to the right of the moving object, {−20, 40} would indicate a distance that is 20 units to the left of the moving object and then 40 units in front of that point, in the direction the digital camera was pointing when the image was generated, and {20, 40} would indicate a distance that is 20 units to the right of the moving object and then 40 units in front of that point, in the direction the digital camera was pointing when the image was generated.

Part of the image may be included in the bounding box and part of the image may not be included in the bounding box. For example, the points directly to the left and right (of the moving object) that are in the bounding box may be out of the view of the digital camera (and thus not depicted in the image) while points in the far distance that are depicted in the image may be outside the bounding box.

### Track Boundary Estimator

Track boundary estimator 130 accepts an image as input and generates output that comprises an estimate of the location of one or more portions of one or more track boundaries that are inside the view of the image and, optionally, portions of one or more track boundaries that are outside the view of the image. For example, track boundary estimator 130 includes a neural network that outputs parameter values of one or more polynomial functions, each of which describes the shape of a portion of a track boundary. As another example, track boundary estimator 130 recognizes certain unique physical markers at a track boundary and determines, based on data in the ground truth database 120, where the track boundary is located in the image. Embodiments are not limited to any particular technique for identifying/estimating/predicting one or more track boundaries within an image.

In an embodiment, given an image, track boundary estimator 130 identifies multiple track boundaries in an image, such as a left boundary and a right boundary. Each identified track boundary becomes separate input to segment pair aligner 140.

Track boundary estimator 130 may convert the format of the initial output into a format that is similar to the format of data that identifies a track boundary in ground truth database 120. For example, if the initial output is parameter values of a polynomial function, then track boundary estimator 130 generates a set of points on a line/curve that is defined by the polynomial function. Segment pair aligner 140 can then compare that set of points (or a transformed/translated version thereof) to one or more segments of a track boundary in ground truth database 120.

### Segment Pair Aligner

Segment pair aligner 140 takes two boundary segments (one from ground truth database 120 and one from track boundary estimator 130) and attempts to align the estimated track boundary segment with an actual track boundary segment. Based on orientation of an image from which an estimated segment is derived, the points that make up the estimated segment may be oriented very differently than the points that make up an actual segment. Therefore, comparing both segments would result in a determination that the two segments do not match. Thus, segment pair aligner 140 may rotate and translate (i.e., move) one of the two segments before a comparison between the two segments.

For example, an estimated track boundary segment may comprise a set of coordinates in Cartesian space that is relative to the point of view of the image from which the estimated track boundary segment was derived. A portion of the actual track boundary may be rotated and oriented (in the Cartesian space of the estimated track boundary segment) to match the orientation of the estimated track boundary segment. The portion may be the same length (or number of points) as the estimated track boundary segment or may be longer than the estimated track boundary segment, such as twice the length. Alternatively, the estimated track boundary segment is translated and rotated relative to the actual (or ground truth) segment (which is extracted from the actual (or ground truth) track), which is likely longer than the estimated track boundary segment. The estimated track boundary segment is then placed and aligned at multiple points of the actual track boundary segment.

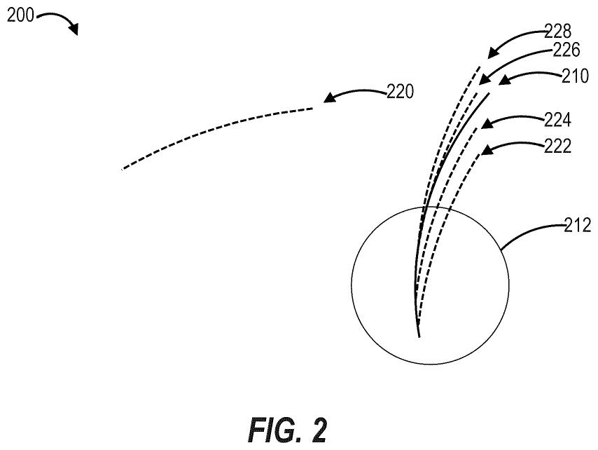

FIG. 2 is a block diagram that depicts an actual track boundary segment 210 (or “actual segment 210”) and an estimated track boundary segment 220 (or estimated segment 220). The two segments appear to be perpendicular to each other in Cartesian space, which may be possible based on the orientation of a camera at the time the camera generated the image from which the estimated track boundary segment 220 was derived.

Estimated segments 222-228 are rotated and translated versions of estimated segment 220. In other words, segment pair aligner 140 rotates a copy of estimated segment 220 and translates (or moves) that copy so that a point of the copy intersects with actual segment 210. Segment pair aligner 140 may limit its search of a match with an actual track boundary to search area 212. (The center of search area 212 may be an estimated longitudinal distance of the moving object, for example, where the moving object typically is on the track after x number of seconds, or an approximation (and less accurate) given by other method.) In this way, segment pair aligner 140 does not have to consider each portion or segment of the entire actual track boundary. Within search area 212 of actual segment 210, segment pair aligner 140 may check each point on actual segment 210 according to a certain length interval between points, such as every centimeter or every meter. Thus, search area 212 delimits the area where the different points of alignment are to be tried. The points of alignment define the positions where the first point of estimated segment 220 is placed for each alignment attempt or try. The best point defines later the longitudinal position of the moving vehicle. Although search area 212 is two-dimensional, the search works as a one-dimensional search interval with respect to the longitudinal coordinate in a reference line-based system. In other words, only points along the actual segment 210 whose longitudinal distance are within the search distance (defined by search area 212) are considered. Search area 212 may still be considered a search “area” because each point in the actual segment has two-dimensional Cartesian coordinates, which change in both coordinates x and y (as long as the segment is curved). For each point of estimated segment 220 and actual segment 210, there is a way to convert from Cartesian coordinates to reference line-based coordinates (longitudinal+lateral coordinates), as described in U.S. patent application Ser. No. 18/367,400, filed on Sep. 12, 2023, which is incorporated by reference as if fully described herein.

Each of estimated segments 222-228 begins on a different point of actual segment 210. These points in the actual segment are called “points of alignment”, each of which could be defined using its Cartesian coordinates, or its reference line-based coordinates. In an embodiment, each point of alignment is defined by its longitudinal coordinate, that is, the longitudinal distance s of the point with respect to an initial reference point. Segment pair aligner 140 generates a difference between each estimated segment and actual segment 210. Each aligning of an estimated segment to an actual segment is referred to as a candidate alignment. Based on a visual evaluation, estimated segment 226 has the least difference relative to actual segment 210 than the other estimated segments.

In an embodiment, the difference between an estimated segment and actual segment 210 is the average distance between pairs of points at each segment, separated at an equal step size at each boundary. This is referred to as the “point-wise distance between segments.” An example formula for computing the point-wise distance (or difference measurement) between segments, at a given point of alignment sₖ is as follows:

$$D ( {s}_{k} ) = \frac{1}{n} {\sum }_{i = 1}^{n}$$

where n is the number of points that are compared, \vec{p}ᵢ^{x} is an x coordinate of point i on an actual segment, [symbol] is an x coordinate of point i on an estimated segment, \vec{p}ᵢ^{y} is a y coordinate of point i on an actual segment, and [symbol] is a y coordinate of point i on an estimated segment.

Once an estimated segment (or its copies) has been placed at all the defined points for alignment against actual segment 210, the best point for alignment is calculated as the position so where the point-wise distance (or difference measurement) between segments is minimized:

$${s}_{0} = {arg min}_{k = 1 .. N} D ( {s}_{k} )$$

The value of (s₀) is the best estimated longitudinal distance of the moving object given estimated segment 220 and actual segment 210. With the above minimization function, different alignments at different longitudinal distances are tried (with respect to the estimated longitudinal distance that acts as the center of search as described), which is why the function is referred to as D(sₖ). For each sₖ, the set of Cartesian points for both the actual and estimated segments may be obtained, which points are used to obtain the distance values.

If a moving object is moving following the reference line of a track with zero skidding (as if the object was moving on rails), then the longitudinal position of the moving object would be the same as the longitudinal position of the points on the left and right boundaries. This is, by definition, due to how track boundaries are processed and how the (s, d) coordinates of each point in the track boundaries are calculated. In this scenario, the x-axis of a camera's coordinates crosses with both track boundaries at points whose longitudinal distance is the same.

However, if the moving object is skidding, such that the camera is not aligned with the direction of motion, then the estimated segments would be slightly different as a result. For example, in a left turn, if a car is oversteering, then the camera (mounted to the car) would be pointed at (1) a portion of the left boundary that starts earlier than if the car was not skidding, and (2) a portion of the right boundary that starts later than if the car was not skidding. When applying the alignment, the first point of each segment after alignment indicates the estimated longitudinal position. In this example, the s value estimated for the left edge would be lower than the correct one, and the s value estimated for the right edge would be greater than the correct one. After calculating the alignment per boundary, both measures may be combined. Because one estimation is overshooting the correct value and the other estimation is undershooting the correct value, when combined, the final estimated longitudinal value should be close to the correct value. Once the estimated longitudinal value is determined, the process ends, at least with respect to that image and that track boundary (or side of the track). If there is another boundary/side of the track and, optionally, other lines or lanes through the track (such as a center line), then the above process repeats for the other boundary and for any other lines through the track, with respect to the current image. Thus, there may be multiple estimated longitudinal values, which can be combined to generate a single longitudinal value for the moving object.

For example, a mean or median longitudinal value may be computed from multiple longitudinal values. As another example, it may be assumed that the closer a moving object is to one boundary, then the more accurate the estimated segment will be. Thus, more weight is given to the longitudinal value that is from the estimated segment whose boundary is closer to the moving object than the other boundary. For example, if a moving object is estimated to be closer to the left boundary of a track than the right boundary of the track, then a 75% weight is given to the longitudinal value associated with the left boundary while 25% weight is given to the longitudinal value associated with the right boundary. As another example, if a moving object is estimated to be 62% of the way from the left boundary to the right boundary, then a 62% weight is given to the longitudinal value associated with the right boundary and a 38% weight is given to the longitudinal value associated with the left boundary. Another example is calculating the uncertainty of each alignment and using the resulting uncertainty values as weights when computing a final estimated longitudinal value, as described in more detail herein.

### Example Process

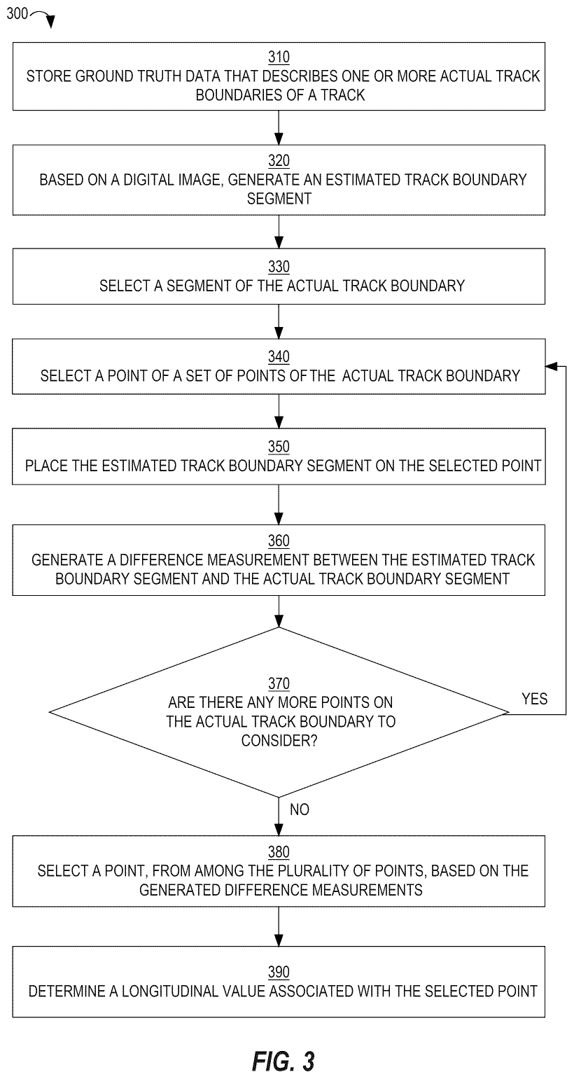

FIG. 3 is a flow diagram that depicts an example process 300 for determining a longitudinal position of a moving object along a trajectory, in an embodiment. Process 300 may be implemented by different components of localization system 100.

At block 310, ground truth data that describes one or more actual track boundaries of a track or path is stored. Each track boundary may be defined by a line and/or a set of points, each point being associated with a longitudinal distance from a beginning of the track.

At block 320, an estimated track boundary segment is generated based on a digital image. The digital image is generated by a digital camera that may be mounted to the moving object as it travels along the trajectory. Block 320 may involve analyzing an image to identify characteristics of a track boundary indicated in the image. Such analyzing may be rule-based using digital image analysis that searches for certain track boundary characteristics. Alternatively, the analyzing may be performed by a machine-learned model that, given the digital image, outputs parameter values of one or more polynomial functions, which describe a line in Cartesian space, the line corresponding to a portion of the track boundary.

At block 330, a segment of the actual track boundary is selected. Block 330 may involve estimating where the moving object is on the track based on one or more of the period of time since the start or the last estimated longitudinal value (if this iteration of process 300 is not the first iteration for this moving object). This estimate is used to define a search area of the actual track boundary. The actual track boundary segment comprises a set of points and may be longer than the estimated track boundary segment.

At block 340, a point of a set of points of the actual track boundary is selected. The set of points may be all of the points on the entire track boundary or may be limited to a strict subset of the track boundary, such as 10% of all points on the entire track boundary (which is described in more detail herein). The point may be selected randomly from the set of points. Alternatively, because each point in the set of points is associated with a longitudinal value, the point may be selected starting from the lowest longitudinal value and, for each subsequent iteration of block 340 with respect to these set of points, the next highest longitudinal value is selected until the point associated with the highest longitudinal value is selected.

At block 350, the beginning of the estimated track boundary segment is placed on the selected point. Block 350 may involve rotating and/or translating the estimated track boundary onto the Cartesian space of the actual track boundary segment so that a difference between the estimated track boundary segment and an actual track boundary segment is minimized. The rotating and translating may be repeated using a binary search technique until the difference ceases to change a threshold amount.

At block 360, a difference measurement between the estimated track boundary segment and the actual track boundary segment is generated. Block 360 may involve adding up the differences between each point in the estimated track boundary segment and the corresponding point in the actual track boundary segment, both segments having been divided in an equal number of points, equally distant. This sum may be used as the difference measurement. Alternatively, this sum may be divided by the number of points in the estimated track boundary segment in order to compute the difference measurement.

At block 370, it is determined whether there are any more points on the actual track boundary to consider. If so, then process 300 returns to block 340 where another point of the set of points is selected. Otherwise, process 300 proceeds to block 380.

At block 380, a point, from among the plurality of points, is selected based on the generated difference measurements from block 360 with respect to a particular digital image. Block 380 may involve identifying the difference measurement that is associated with each point in the set of points and selecting the point that is associated with the lowest difference measurement.

At block 390, a longitudinal value associated with the selected point is determined. Each point on the actual track boundary segment is associated with a different longitudinal value. The determined longitudinal value is an estimated longitudinal value of the moving object.

Blocks 320-390 may repeat for each estimated track boundary segment or estimated lane segment in the digital image. Also, blocks 320-380 may repeat for each of multiple digital images or frames of video data, such as a live video stream from a digital camera that is mounted to the moving object.

### Uncertainty Generator

In an embodiment, uncertainty generator 150 generates an uncertainty value for each match or comparison between an estimated segment and an actual segment. An uncertain value for an estimated segment may be computed as follows:

First, all the distance values calculated at the different steps, defined by the longitudinal distance (sₖ) of each of the points of alignment of the actual segment, are normalized by the distance at the best point for alignment:

$$Δ ( {s}_{k} ) = \frac{D ( {s}_{k} )}{D ( {s}_{0} )} , where Δ ( {s}_{k} = {s}_{0} ) = 1$$

Second, assuming a normal distribution of the distance values, the distances can be described using the following probability density function:

$$\frac{1}{σ \sqrt{2 π}} {e}^{- \frac{1}{2} \frac{{( x - μ )}^{2}}{{σ}^{2}}}$$

The probability of each alignment at the longitudinal distance sₖ as can be simplified and approximated with the following equation:

$$P ( {s}_{k} ) = {e}^{- Δ ( {s}_{k} )}$$

Finally, the uncertainty of the best alignment at the longitudinal distance s₀ is calculated as follows:

$${σ}_{s}^{2} = \frac{{\sum }_{k = 1}^{n} {( {s}_{k} - {s}_{0} )}^{2} P ( {s}_{k} )}{{\sum }_{k = 1}^{n} P ( {s}_{k} )}$$

With this uncertainty value for the best alignment for the estimated segment, multiple decisions may be made, such as using the uncertainty values associated with left and right boundaries to generate a final longitudinal value with an uncertainty value.

### Alignment Combiner

In an embodiment, alignment combiner 160 takes multiple uncertainty values associated with the best alignments found for different estimated segments derived from the same image to determine a single longitudinal value for a moving object. For example, the best alignment for the estimated segment of a left boundary of a track is used to determine a first longitudinal value of a moving object and the best alignment for a second estimated segment of a right boundary of the track is used to determine a second longitudinal value of the moving object. Uncertainty generator 150 generates a first uncertainty value based on the all the alignments of the first estimated segment, and generates a second uncertainty value based on the all the alignment of the second estimated segment. The alignment of the estimated segment of the boundary that has a lower uncertainty value contributes more to the final longitudinal value than the alignment of the estimated segment of the boundary that has a larger uncertainty value. An example of a formula that takes into account both uncertainty values to generate a final longitudinal value is the following:

$$\hat{s} = \frac{{w}_{L} {\hat{s}}_{L} + {w}_{R} {\hat{s}}_{R}}{{w}_{L} + {w}_{R}}$$

where ŝ_{L} is the longitudinal distance of the best alignment found for the estimated segment that describes the left track boundary, SR is the longitudinal distance of the best alignment found for the estimated segment that describes the right track boundary, w_{L} is the weight of the best alignment found for the estimated segment that describes the left track boundary (which may defined as

$${w}_{L} = 1 - \frac{{σ}_{L}^{2}}{{σ}_{L}^{2} + {σ}_{R}^{2}} ) ,$$

and w_{R} is the weight of the best alignment found for the estimated segment that describes the right track boundary (which may be defined as

$${w}_{R} = 1 - \frac{{σ}_{R}^{2}}{{σ}_{L}^{2} + {σ}_{R}^{2}} ) ,$$

where σ_{L}² is the uncertainty of the alignment for the left track boundary and σ_{R}² is the uncertainty of the alignment for the right track boundary. The uncertainty of the final longitudinal value may be the weighted average of the uncertainties for the alignments of the left and right estimated track boundaries.

### Uncertainty Value Generation Optimization

Uncertainty value generation may be a computationally intensive process, especially as the number of candidate alignment points for a track boundary increases. In other words, the greater the number of these points per estimated track boundary per image, the greater the time and computer resources expended to identify the final alignment of the given estimated segment for the track boundary.

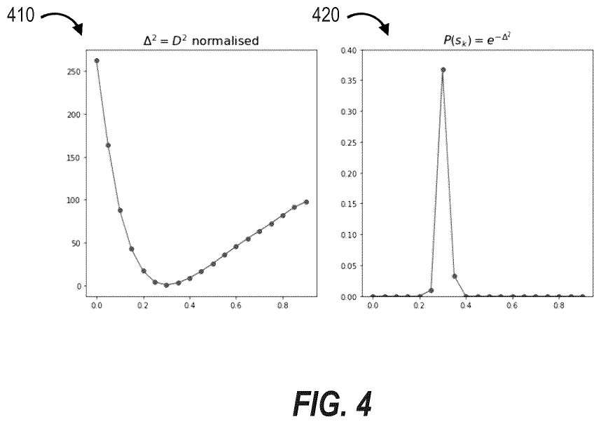

There is a way to optimize the process that uncertainty generator 150 implements to generate an uncertainty value. On a curved section of a track, the point-wise distance between the different alignments of the estimated segment and the actual segment will typically show a parabolic shape (see chart 410 in FIG. 4), which will result in a peak in the function P(sₖ) (see chart 420 in FIG. 4). The narrower the peak, the more certain the alignment method and vice versa. The x-axis in charts 410 and 420 is the distance from a beginning point on an actual segment from where an estimated segment is placed for a candidate alignment, while the y-axis in chart 410 is the squared point-wise distance between two segments for a given candidate alignment. The y-axis in chart 420 is the P(sₖ) values for each candidate alignment.

As can be seen from the charts in FIG. 4, not all of the distribution is required in order to obtain an uncertainty value. This is because, when a good alignment happens, most of the P(sₖ) values will be zero or near zero, apart from the candidate alignments that are closer to the mean μₛ. In other words, in the neighborhood of s₀, where corrections are small, it would be inefficient to compute the uncertainty σₛ² using values of sₖ that are far from s₀.

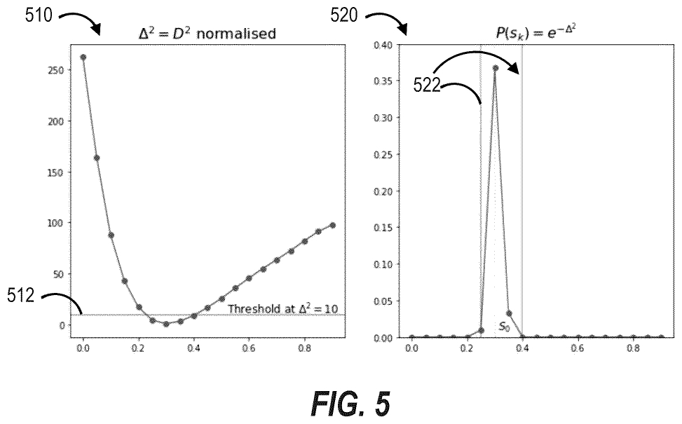

Therefore, an uncertainty value is generated by using only the values that are closer to the tip of the curve, and not the whole curve P(sₖ). For example, only squared normalized distance values lower than a given threshold value, e.g., Δ²(sₖ)≤10 may be used, since these are the main contributors for the shape of the Gaussian-like distribution P(sₖ). FIG. 5 depicts the same charts as in FIG. 4, except for a threshold squared normalized distance value (i.e., 10) that limits the number of candidate alignments to consider for generating an uncertainty value. In this depicted example in chart 510, only four candidate alignments are associated with normalized distance values under the given threshold. Then, only four P(sₖ) values in chart 520 (i.e., between the two vertical lines) are considered in order generate an uncertain value for a final alignment.

If only the points of alignment that are in the neighborhood of s₀ are considered, then the function Δ(sₖ) may be approximated as a parabola of a certain curvature determined by the coefficient c, whose minimum is at s₀, and its minimum value is 1 (Δ(s₀)=1). Therefore, the squared normalized distance at each sₖ may be considered as Δ(s_{K})=Δ(s₀)+c sₖ−s₀)², by Taylor expansion, the following formula is derived:

$$Δ ( {s}_{k} ) = Δ ( {s}_{0} ) + \frac{δΔ}{δ {s}_{k}} ( {s}_{k} - {s}_{0} ) + \frac{1}{2} \frac{{δ}^{2} Δ}{{δ}^{2} {s}_{k}} {( {s}_{k} - {s}_{0} )}^{2} + …$$

$$where :$$

$$\frac{δΔ}{δ {s}_{k}} ( {s}_{k} - {s}_{0} ) = 0$$

and a normal distribution of values is assumed; therefore, the curve follows approximately e^{-A(s}^{ₖ}⁾. As a result, it is more convenient to recognize that

$$Δ ( {s}_{k} ) \approx Δ ( {s}_{0} ) + \frac{1}{2} \frac{{( {s}_{k} - {s}_{0} )}^{2}}{{σ}_{s}^{2}} ,$$

instead of considering all actual values of Δₖ and evaluate Δ(sₖ) with sₖ−s₀≈σₛ. To do so, the following function Q is minimized, where Q is defined as:

$$Q = {\sum }_{k = 1}^{n} {( Δ ( {s}_{k} ) - Δ ( {s}_{0} ) - \frac{1}{2} \frac{{( {s}_{k} - {s}_{0} )}^{2}}{{σ}_{s}^{2}} )}^{2} so that {σ}_{s} = {arg min}_{σ} Q$$

The uncertainty can then be mathematically derived as follows:

$${σ}_{s}^{2} = \frac{{\sum }_{k = 1}^{n} {( {s}_{k} - {s}_{0} )}^{4}}{{\sum }_{k = 1}^{n} 2 ( Δ ( {s}_{k} ) - Δ ( {s}_{0} ) ) {( {s}_{k} - {s}_{0} )}^{2}}$$

If the approximate position of a moving object is known, then the search area for the best alignment may be restricted by the known error of the measured position, which known error comes from the system that provides the approximate position of the moving object. The search area for the next digital image may be based on this known error of the approximate measured position, or a function of the uncertainty of the best alignment for the previous digital image or series of images. If no approximate uncertainty value can be used to determine the search area, then the alignment method could still define a fixed search area around an approximate position, based on other information, such as the time that has passed since the vehicle started moving in a controlled environment, e.g. a race track, compared to the historical record of vehicles covering similar trajectories. Otherwise, in the absence of any other related information that can be leveraged, the alignment method might be executed against all possible positions in the ground truth map and, therefore, the alignment method will take more time. The greater the uncertainty, the larger the search area. Conversely, the lower the uncertainty, the smaller the search area.

This optimized uncertainty generation technique has four hyperparameters that may be optimized:
a. Radius of search for the alignment of estimated segments with the ground truth data. This search radius can be set statically with a constant value for each frame, or dynamically with a value that increases or shrinks dynamically based on previous alignments for the same moving object. If the uncertainties of the previous alignments are below a given threshold and the derivatives of these uncertainties are negative (meaning the uncertainties are decreasing), then the search radius can be confidently reduced. Conversely, the search radius can be confidently increased if the derivatives are positive.
b. Step size for the alignment method. For example, the step size may be the distance between points on the actual track boundary, such as one centimeter, or may be larger or smaller than that distance.
c. Length of the portion of ground truth track boundaries that are extracted from the ground truth data. For example, the length may be a default length or may be based on the length of an estimated segment, such as twice the length of an estimated segment. Thus, the length of the portion of the ground truth track boundary may change from frame to frame (or image to image), depending on the length of the estimated segment that was identified in the view of the image.
d. Length of the estimated track boundary segment, determined by their evaluation from their polynomial or parametric representation.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

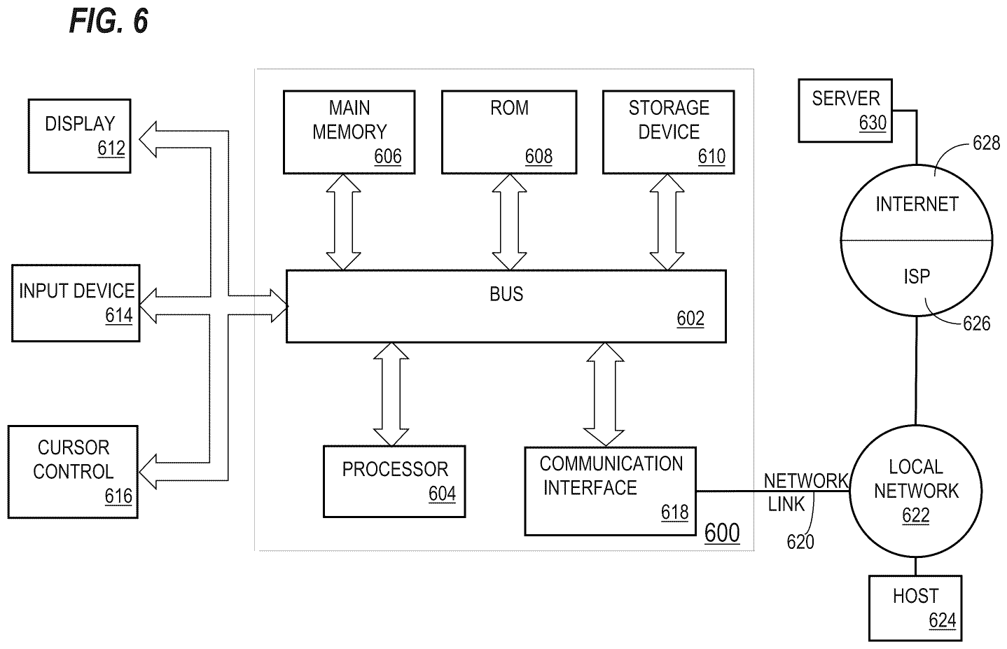

For example, FIG. 6 is a block diagram that illustrates a computer system 600 upon which an embodiment of the invention may be implemented. Computer system 600 includes a bus 602 or other communication mechanism for communicating information, and a hardware processor 604 coupled with bus 602 for processing information. Hardware processor 604 may be, for example, a general purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk, optical disk, or solid-state drive is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 610. Volatile media includes dynamic memory, such as main memory 606. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid-state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

### Software Overview

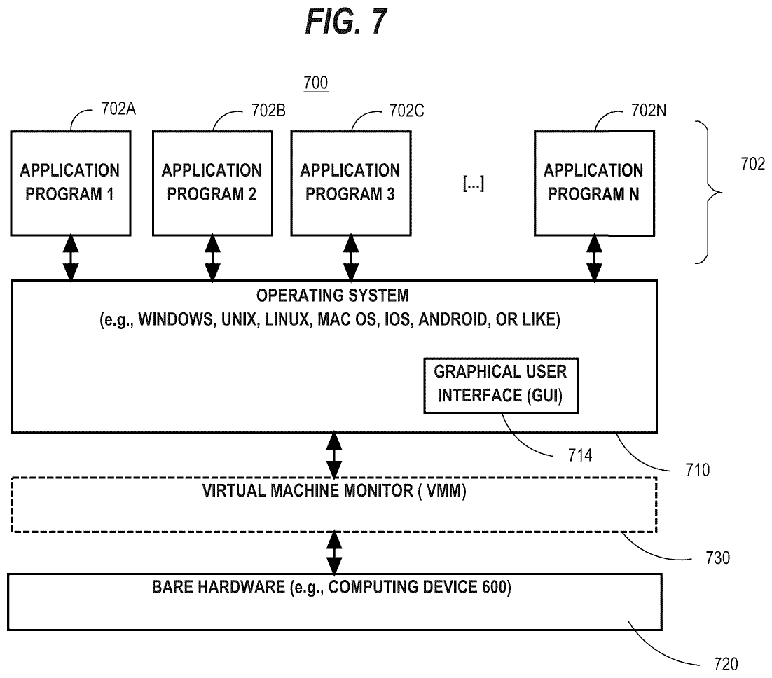

FIG. 7 is a block diagram of a basic software system 700 that may be employed for controlling the operation of computer system 600. Software system 700 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 700 is provided for directing the operation of computer system 600. Software system 700, which may be stored in system memory (RAM) 606 and on fixed storage (e.g., hard disk or flash memory) 610, includes a kernel or operating system (OS) 710.

The OS 710 manages low-level aspects of computer operation, including managing execution of processes, memory allocation, file input and output (I/O), and device I/O. One or more application programs, represented as 702A, 702B, 702C . . . 702N, may be “loaded” (e.g., transferred from fixed storage 610 into memory 606) for execution by the system 700. The applications or other software intended for use on computer system 600 may also be stored as a set of downloadable computer-executable instructions, for example, for downloading and installation from an Internet location (e.g., a Web server, an app store, or other online service).

Software system 700 includes a graphical user interface (GUI) 715, for receiving user commands and data in a graphical (e.g., “point-and-click” or “touch gesture”) fashion. These inputs, in turn, may be acted upon by the system 700 in accordance with instructions from operating system 710 and/or application(s) 702. The GUI 715 also serves to display the results of operation from the OS 710 and application(s) 702, whereupon the user may supply additional inputs or terminate the session (e.g., log off).

OS 710 can execute directly on the bare hardware 720 (e.g., processor(s) 604) of computer system 600. Alternatively, a hypervisor or virtual machine monitor (VMM) 730 may be interposed between the bare hardware 720 and the OS 710. In this configuration, VMM 730 acts as a software “cushion” or virtualization layer between the OS 710 and the bare hardware 720 of the computer system 600.

VMM 730 instantiates and runs one or more virtual machine instances (“guest machines”). Each guest machine comprises a “guest” operating system, such as OS 710, and one or more applications, such as application(s) 702, designed to execute on the guest operating system. The VMM 730 presents the guest operating systems with a virtual operating platform and manages the execution of the guest operating systems.

In some instances, the VMM 730 may allow a guest operating system to run as if it is running on the bare hardware 720 of computer system 600 directly. In these instances, the same version of the guest operating system configured to execute on the bare hardware 720 directly may also execute on VMM 730 without modification or reconfiguration. In other words, VMM 730 may provide full hardware and CPU virtualization to a guest operating system in some instances.

In other instances, a guest operating system may be specially designed or configured to execute on VMM 730 for efficiency. In these instances, the guest operating system is “aware” that it executes on a virtual machine monitor. In other words, VMM 730 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

The above-described basic computer hardware and software is presented for purposes of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
generating an estimated track boundary segment based on a digital image associated with a moving object;
for each position of a plurality of positions in an actual track boundary segment pertaining to a track for one or more moving objects:
based on said each position, making an alignment of the estimated track boundary segment with the actual track boundary segment;
based on the alignment, generating a difference measurement between the estimated track boundary segment and a portion of the actual track boundary segment;
selecting a particular alignment, of a plurality of alignments, that is associated with the lowest difference measurement among the plurality of positions;
based on the particular alignment, determining a longitudinal value of the moving object;
wherein the method is performed by one or more computing devices.

2. The method of claim 1, wherein determining the longitudinal value comprises:
based on the particular alignment, determining a point on the actual track boundary segment that is associated with the particular alignment of the estimated track boundary segment with the actual track boundary segment;
identifying the longitudinal value that is associated with the point.

3. The method of claim 1, wherein the estimated track boundary segment is a first estimated track boundary segment that is associated with a first boundary of the track, wherein the particular alignment is a first particular alignment, wherein the longitudinal value is a first longitudinal value, the method further comprising:
generating a second estimated track boundary segment based on the digital image;
for each position of a second plurality of positions in a second actual track boundary segment pertaining to the track:
based on each position, making a second alignment of the second estimated track boundary segment with the second actual track boundary segment;
based on the second alignment, generating a second difference measurement between the second estimated track boundary segment and a portion of the second actual track boundary segment;
selecting a second particular alignment, of a second plurality of alignments, that is associated with the lowest difference measurement among the second plurality of positions;
based on the second particular alignment, determining a second longitudinal value of the moving object.

4. The method of claim 3, further comprising:
generating a final longitudinal value of the moving object based on the first longitudinal value and the second longitudinal value.

5. The method of claim 4, further comprising:
determining whether the moving object is closer to the first estimated track boundary segment or to the second estimated track boundary;
wherein generating the final longitudinal value comprises applying more weight to the first longitudinal value than to the second longitudinal value in response to determining that the moving object is closer to the first estimated track boundary segment than to the second estimated track boundary segment.

6. The method of claim 4, further comprising:
generating a first uncertainty value that is associated with the first longitudinal value;
generating a second uncertainty value that is associated with the second longitudinal value;
wherein generating the final longitudinal value is also based on the first uncertainty value and the second uncertainty value.

7. The method of claim 4, further comprising:
determining an uncertainty of the first particular alignment of the first estimated track boundary segment and an uncertainty of the second particular alignment of the second estimated track boundary segment;
wherein generating the final longitudinal value comprises applying more weight to the first longitudinal value than to the second longitudinal value in response to determining which alignment is more uncertain than the other.

8. The method of claim 1, further comprising:
for each alignment of the plurality of alignments:
determining a difference between the difference measurement of said each alignment and the lowest difference measurement;
adding the difference to a set of differences;
generating an uncertainty value for the particular alignment based on the set of differences.

9. The method of claim 8, further comprising:
for each alignment of the plurality of alignments:
determining a normalized difference between the difference measurement of said each alignment and the lowest difference measurement;
wherein generating the uncertainty value for the particular alignment is also based on the normalized difference.

10. The method of claim 1, further comprising:
storing ground truth data about an actual track boundary, of which the actual track boundary segment is a part;
wherein the actual track boundary comprises a set of positions, each of which is associated with a longitudinal value;
wherein the plurality of positions is a strict subset of the set of positions;

11. The method of claim 10, further comprising:
generating an uncertainty value for the particular alignment based on the set of differences;
for a second digital image that is subsequent to the digital image, determining a search area size of the actual track boundary based on the uncertainty value;
wherein a number of positions of the actual track boundary to consider for aligning a second actual track boundary segment with a second estimated track boundary segment, that is generated based on the second digital image, is directly proportional to the search area size.

12. The method of claim 10, further comprising:
for a second digital image that is subsequent to the digital image, determining a search area size of the actual track boundary based on an approximate position of the moving object and a known error of the approximate position.

13. The method of claim 10, further comprising:
for a second digital image that is subsequent to the digital image, determining a search area size of the actual track boundary based on an amount of time that has passed since the moving object began moving in a controlled environment.

14. One or more non-transitory storage media storing instructions which, when executed by one or more computing devices, cause:
generating an estimated track boundary segment based on a digital image associated with a moving object;
for each position of a plurality of positions in an actual track boundary segment pertaining to a track for one or more moving objects:
based on said each position, making an alignment of the estimated track boundary segment with the actual track boundary segment;
based on the alignment, generating a difference measurement between the estimated track boundary segment and a portion of the actual track boundary segment;
selecting a particular alignment, of a plurality of alignments, that is associated with the lowest difference measurement among the plurality of positions;
based on the particular alignment, determining a longitudinal value of the moving object.

15. The one or more storage media of claim 14, wherein determining the longitudinal value comprises:
based on the particular alignment, determining a point on the actual track boundary segment that is associated with the particular alignment of the estimated track boundary segment with the actual track boundary segment;
identifying the longitudinal value that is associated with the point.

16. The one or more storage media of claim 14, wherein the estimated track boundary segment is a first estimated track boundary segment that is associated with a first boundary of the track, wherein the particular alignment is a first particular alignment, wherein the longitudinal value is a first longitudinal value, wherein the instructions, when executed by the one or more computing devices, further cause:
generating a second estimated track boundary segment based on the digital image;
for each position of a second plurality of positions in a second actual track boundary segment pertaining to the track:
based on each position, making a second alignment of the second estimated track boundary segment with the second actual track boundary segment;
based on the second alignment, generating a second difference measurement between the second estimated track boundary segment and a portion of the second actual track boundary segment;
selecting a second particular alignment, of a second plurality of alignments, that is associated with the lowest difference measurement among the second plurality of positions;
based on the second particular alignment, determining a second longitudinal value of the moving object.

17. The one or more storage media of claim 16, wherein the instructions, when executed by the one or more computing devices, further cause:
generating a final longitudinal value of the moving object based on the first longitudinal value and the second longitudinal value.

18. The one or more storage media of claim 17, wherein the instructions, when executed by the one or more computing devices, further cause:
determining whether the moving object is closer to the first estimated track boundary segment or to the second estimated track boundary;
wherein generating the final longitudinal value comprises applying more weight to the first longitudinal value than to the second longitudinal value in response to determining that the moving object is closer to the first estimated track boundary segment than to the second estimated track boundary segment.

19. The one or more storage media of claim 17, wherein the instructions, when executed by the one or more computing devices, further cause:
generating a first uncertainty value that is associated with the first longitudinal value;
generating a second uncertainty value that is associated with the second longitudinal value;
wherein generating the final longitudinal value is also based on the first uncertainty value and the second uncertainty value.

20. The one or more storage media of claim 17, wherein the instructions, when executed by the one or more computing devices, further cause:
determining an uncertainty of the first particular alignment of the first estimated track boundary segment and an uncertainty of the second particular alignment of the second estimated track boundary segment;
wherein generating the final longitudinal value comprises applying more weight to the first longitudinal value than to the second longitudinal value in response to determining which alignment is more uncertain than the other.
